(19) United States
(12) Patent Application Publication
(10) Pub. No.: US 2018/0282471 A1
(43) Pub. Date: Oct. 4, 2018

(54) Thermoplastic Polyurethane Compositions For Solid Freeform Fabrication

(71) Applicant: Lubrizol Advanced Materials, Inc., Cleveland, OH (US)

(72) Inventors: Jennifer Green, Brecksville, OH (US); John M. Cox, Broadview Heights, OH (US); Joseph J. Vontorcik, Jr., Broadview Heights, OH (US); Barbara Morgan, Shaker Heights, OH (US)

(21) Appl. No.: 15/764,359

(22) PCT Filed: Sep. 29, 2016
(86) PCT No.: PCT/US16/54363

§ 371 Date: Mar. 29, 2018

Related U.S. Application Data
(60) Provisional application No. 62/235,664, filed on Oct. 1, 2015.

(51) Int. Cl. C08G 18/73; C08G 18/72; C08G 18/66; C08G 18/48; C08G 18/32; B29C 64/118; B29C 64/153

(52) U.S. Cl. CPC C08G 18/73; C08G 18/722; C08G 18/6674; B29L 2031/7534; C08G 18/3206; B29C 64/118; B29C 64/153; C08G 18/4833

(57) ABSTRACT

The invention relates to compositions and methods for solid freeform fabrication of medical devices, components and applications in which the composition includes a thermoplastic polyurethane which is particularly suited for such processing. The useful thermoplastic polyurethanes are derived from a polyisocyanate component including a first linear aliphatic diisocyate and a second aliphatic diisocyanate, a polyol component, and (c) a chain extender component.

### FIELD OF THE INVENTION

The invention relates to compositions and methods for the direct solid freeform fabrication of medical devices, components and applications. The medical devices, components and applications can be formed from biocompatible thermoplastic polyurethanes suited for such processing. The useful thermoplastic polyurethanes are derived from (a) at least a first linear aliphatic diisocyanate and a second aliphatic diisocyanate, (b) a polyether polyol component, and a chain extender component.

### BACKGROUND

Solid Freeform Fabrication (SFF), also referred to as additive manufacturing, is a technology enabling fabrication of arbitrarily shaped structures directly from computer data via additive formation steps. The basic operation of any SFF system consists of slicing a three-dimensional computer model into thin cross sections, translating the result into two-dimensional position data and feeding the data to control equipment which fabricates a three-dimensional structure in a layerwise manner.

Solid freeform fabrication entails many different approaches, including three-dimensional printing, electron beam melting, stereolithography, selective laser sintering, laminated object manufacturing, fused deposition modeling and others.

The differences between these processes lies in the way the layers are placed to create parts, as well as in the materials utilized. Some methods, such as selective laser sintering (SLS), fused deposition modeling (FDM) or fused filament fabrication (FFF), melt or soften the material to produce the layers. Other methods, such as stereolithography (SLA), cure liquid materials.

Typically, additive manufacturing for thermoplastics utilizes two types of printing methods. In the first method, known as an extrusion type, a filament and/or a resin (referred to as “pellet printing”) of the subject material is softened or melted then deposited by the machine in layers to form the desired object. Extrusion type methods are known as fused deposition modeling (FDM) or fused filament fabrication (FFF). In extrusion methods, a thermoplastic resin or a strand of thermoplastic filament is supplied to a nozzle head which heats the thermoplastic and turns the flow on and off. The part is constructed by extruding small beads of material which harden to form layers.

The second method is the powder or granular type where a powder is deposited in a granular bed and then fused to the previous layer by selective fusing or melting. The technique typically fuses parts of the layer using a high powered laser. After each cross-section is processed, the powder bed is lowered. A new layer of powdered material is then applied and the steps are repeated until the part is fully constructed. Often, the machine is designed with the capability to preheat the bulk powder bed material to slightly below its melting point. This reduces the amount of energy and time for the laser to increase the temperature of the selected regions to the melting point.

Unlike extrusion methods, the granular or powder methods use the unfused media to support projections or ledges and thin walls in the part being produced. This reduces or eliminates the need for temporary supports as the piece is being constructed. Specific methods include selective laser sintering (SLS), selective heat sintering (SHS) and selective laser melting (SLM). In SLM, the laser completely melts the powder. This allows the formation of a part in a layer-wise method that will have the mechanical properties similar to those of conventionally manufactured parts. Another powder or granular method utilizes an inkjet printing system. In this technique, the piece is created layer-wise by printing a binder in the cross-section of the part using an inkjet-like process on top of a layer of powder. An additional layer of powder is added and the process is repeated until each layer has been printed.

Current solid freeform fabrication for medical devices and applications has been focused on indirect fabrication, such as printing of molds which are subsequently filled with a material or the printing of a form over which a thermoformed device is then molded; or for medical applications involving visualization, demonstration and mechanical prototyping, e.g. where expected outcomes can be modeled prior to performing procedures based on a 3D-printed prototype. Thus, SFF facilitates rapid fabrication of functioning prototypes with minimal investment in tooling and labor. Such rapid prototyping shortens the product development cycle and improves the design process by providing rapid and effective feedback to the designer. SFF can also be used for rapid fabrication of non-functional parts, e.g., models and the like, for the purpose of assessing various aspects of a design such as aesthetics, fit, assembly and the like.

Current materials utilized in additive manufacturing for medical applications typically include ABS, nylon, polycarbonates, PEEK, polycaprolactone, polylactic acid (PLA), poly-L-lactic acid (PLLA) and photopolymers/cured liquid materials. Some of these materials are limited to applications outside the body, such as prototypes, molds, surgical planning and anatomical models, owing to their lack of biocompatibility or long term biodurability. Additionally, all of these materials are non-elastomeric, thus lacking the properties and benefits of elastomers.

Given the attractive combination of properties thermoplastic polyurethanes offer, and the wide variety of articles made using more conventional means of fabrication, it would be desirable to identify and/or develop thermoplastic polyurethanes well suited for direct solid freeform fabrication of medical devices and components, surgical planning and medical applications.

### SUMMARY

The disclosed technology provides a medical device or component including an additive-manufactured thermoplastic polyurethane composition derived from (a) a polyisocyanate component comprising at least a first linear aliphatic diisocyanate and a second aliphatic diisocyanate in a weight ratio of first linear aliphatic diisocyanate to the second aliphatic diisocyanate from 1:1 to 20:1, (b) a polyol component comprising at least one polyether polyol, and (c) a chain extender component comprising at least one diol chain extender of the general formula HO—(CH₂)ₓ—OH wherein x is an integer from 2 to about 6; in which the molar ratio of chain extender component to polyol component is at least 1.5.

The disclosed technology further provides a medical device or component in which wherein the molar ratio of chain extender to polyol component is from 1.5 to 15.0.

The disclosed technology further provides a medical device or component in which the molar ratio of chain extender to polyol component is from 1:1 to 19:1.

The disclosed technology further provides a medical device or component in which the additive manufacturing comprises fused deposition modeling or selective laser sintering.

The disclosed technology further provides a medical device or component in which the thermoplastic polyurethane is biocompatible.

The disclosed technology further provides a medical device or component in which the polyol has a number average molecular weight of at least 500.

The disclosed technology further provides a medical device or component in which the polyol component has a number average molecular weight of from 500 to 3,000.

The disclosed technology further provides a medical device or component in which the first and second aliphatic diisocyanate components include 1,6-hexanediisocyanate and H12MDI.

The disclosed technology further provides a medical device or component in which the polyol component includes a polyether polyol one or more of PTMO, PEG or combinations thereof.

The disclosed technology further provides a medical device or component in which the molar ratio of chain extender to polyol is from 30:1 to 0.5:1.

The disclosed technology further provides a medical device or component in which the molar ratio of chain extender to polyol is from 21:1 to 0.7:1.

The disclosed technology further provides a medical device or component in which the chain extender component includes 1, 4-butanediol.

The disclosed technology further provides a medical device or component in which the chain extender component includes from 2 wt % to 30 wt % of the total weight of the composition.

The disclosed technology further provides a medical device or component in which the polyisocyanate component further includes MDI, TDI, IPDI, LDI, BDI, PDI, CHDI, TODI, NDI, HXDI or any combination thereof.

The disclosed technology further provides a medical device or component in which the polyol component further includes a polyester polyol, a polycarbonate polyol, a polysiloxane polyol, a polyamide oligomer polyol, or any combination thereof.

The disclosed technology further provides a medical device or component in which the chain extender component further includes one or more additional diol chain extenders, diamine chain extenders, or a combination thereof.

The disclosed technology further provides a medical device or component in which the chain extender component includes 1,4-butane diol and the polyol component comprises poly(tetramethylene ether glycol).

The disclosed technology further provides a medical device or component in which the chain extender component includes 1,4-butanediol and the polyol component comprises PEG.

The disclosed technology further provides a medical device or component in which the chain extender component includes 1,4-butane diol and the polyol component comprises a combination of poly(tetramethylene ether glycol) and PEG.

The disclosed technology further provides a medical device or component in which the thermoplastic polyurethane includes further includes one or more colorants, radio opacifiers, antioxidants (including phenolics, phosphites, thiesters, and/or amines) stabilizers, lubricants, inhibitors, hydrolysis stabilizers, light stabilizers, hindered amine light stabilizers, benzotriazole UV absorbers, heat stabilizers, stabilizers to prevent discoloration, dyes, pigments, reinforcing agents, or any combination thereof.

The disclosed technology further provides a medical device or component in which the thermoplastic polyurethane is free of inorganic, organic or inert fillers.

The disclosed technology further provides a medical device or component in which the medical device or component comprises one or more of a pacemaker lead, an artificial organ, an artificial heart, a heart valve, an artificial tendon, an artery or vein, a pacemaker head, an angiography catheter, an angioplasty cathether, an epidural catheter, a thermal dilution catheter, a urology catheter, a catheter connector, a stent covering, an implant, a medical bag, a prosthetic device, a cartilage replacement, a hair replacement, a joint replacement, a medical valve, a medical tube, a drug delivery device, a bioabsorbable implant, a medical prototype, a medical model, an orthotic, a bone, a dental item, or a surgical tool.

The disclosed technology further provides a medical device or component in which the device or component is personalized to a patient.

The disclosed technology further provides a medical device or component in which the medical device or component includes an implantable or non-implantable device or component.

The disclosed technology further provides a medical device made using a solid free-form fabrication method including a thermoplastic polyurethane derived from (a) a polyisocyanate component including at least a first linear aliphatic diisocyanate and a second aliphatic diisocyanate in a weight ratio of first linear aliphatic diisocyanate to the second aliphatic diisocyanate from 1:1 to 20:1, (b) a polyether polyol component, and (c) a chain extender component; in which the ratio of (c) to (b) is from 1.5 to 15.0; and the thermoplastic polyurethane is deposited in successive layers to form a three-dimensional medical device or component.

The disclosed technology further provides a method of directly fabricating a three-dimensional medical device or component, comprising the step of: (I) operating a system for solid freeform fabrication of an object in which the system includes a solid freeform fabrication apparatus that operates to form a three-dimensional medical device or component from a building material including a thermoplastic polyurethane derived from (a) a polyisocyanate component comprising at least a first linear aliphatic diisocyanate and a second aliphatic diisocyanate in a weight ratio of first linear aliphatic diisocyanate to the second aliphatic diisocyanate from 1:1 to 20:1, (b) a polyether polyol component, and (c) a chain extender component.

The disclosed technology further provides a directly formed medical device or component, including a selectively deposited thermoplastic polyurethane composition derived from (a) a polyisocyanate component comprising at least a first linear aliphatic diisocyanate and a second aliphatic diisocyanate in a weight ratio of first linear aliphatic diisocyanate to the second aliphatic diisocyanate from 1:1 to 20:1, (b) a polyether polyol component, and (c) a chain extender component, in which the molar ratio of chain extender component to polyol component is at least 1.5.

The disclosed technology further provides a directly formed medical device or component for use in a medical application, including a selectively deposited thermoplastic polyurethane composition derived from (a) a polyisocyanate component comprising at least a first linear aliphatic diisocyanate and a second aliphatic diisocyanate in a weight ratio of first linear aliphatic diisocyanate to the second aliphatic diisocyanate from 1:1 to 20:1, (b) a polyether polyol component, and (c) a chain extender component, in which the molar ratio of chain extender component to polyol component is at least 1.5.

The disclosed technology further provides a directly formed medical device or component for use in a medical application in which the medical application comprises one or more of a dental, an orthotic, a maxio-facial, an orthopedic, or a surgical planning application.

### DETAILED DESCRIPTION

Various preferred features and embodiments will be described below by way of non-limiting illustration.

The disclosed technology provides thermoplastic polyurethane compositions useful for the direct solid freeform fabrication of medical devices and components. The described thermoplastic polyurethanes are biocompatible and biodurable, as well as being free from processing aids and inert fillers required by conventional materials used for solid freeform fabrication methods of medical devices and components. By biocompatible it is meant that the material performs with an appropriate host response in a specific situation and can be exemplified by acceptable standardized test results for sensitization, irritation and/or cytotoxicity response as a minimum requirement.

### The Thermoplastic Polyurethanes.

The TPU compositions described herein are made using: (a) a polyisocyanate component, which includes at least a first and a second linear aliphatic diisocyanate.

In some embodiments, the linear aliphatic diisocyanates may include 1,6-hexanediisocyanate (HDI), bis(isocyanatomethyl)cyclohexane (HXDI), and dicyclohexylmethane-4,4′-diisocyanate (H12MDI), and combinations thereof. In some embodiments, the polyisocyanate component comprises 1,6-hexanediisocyanate. In some embodiments, the polyisocyanate component comprises HXDI.

In some embodiments, the polyisocyanate component may include one or more additional polyisocyanates, which are typically diisocyanates.

Suitable polyisocyanates which may be used in combination with the linear aliphatic diisocyanates described above may include linear or branched aromatic diisocyanates, branched aliphatic diisocyanates, or combinations thereof. In some embodiments, the polyisocyanate component includes one or more aromatic diisocyanates. In other embodiments, the polyisocyanate component is essentially free of, or even completely free of, aromatic diisocyanates.

These additional polyisocyanates may include 4,4″-methylenebis(phenyl isocyanate) (MDI), toluene diisocyanate (TDI), isophorone diisocyanate (IPDI), lysine diisocyanate (LDI), 1,4-butane diisocyanate (BDI), 1,4-phenylene diisocyanate (PDI), 1,4-cyclohexyl diisocyanate (CHDI), 3,3′-dimethyl-4,4′-biphenylene diisocyanate (TODI), 1,5-naphthalene diisocyanate (NDI), bis(isocyanatomethyl)cyclohexane, or any combination thereof.

In some embodiments, the described TPU is prepared with a polyisocyanate component that includes HDI and H12MDI. In some embodiments, the TPU is prepared with a polyisocyanate component that consists essentially of HDI and H12MDI. In some embodiments, the TPU is prepared with a polyisocyanate component that consists of HDI and H12MDI. In some embodiments, the polyisocyanate includes, or consists of, or even consists essentially of HXDI.

In some embodiments, the thermoplastic polyurethane is prepared with a polyisocyanate component that includes (or consists essentially of, or even consists of) HDI, HXDI, H12MDI and at least one of MDI, TDI, IPDI, LDI, BDI, PDI, CHDI, TODI, and NDI.

In still other embodiments, the polyisocyanate component is essentially free of (or even completely free of) any non-linear aliphatic diisocyanates, any aromatic diisocyanates, or both. In still other embodiments, the polyisocyanate component is essentially free of (or even completely free of) any polyisocyanate other than the linear aliphatic diisocyanates described above. In some embodiments, the first linear aliphatic diisocyanate is HDI and the second aliphatic diisocyanate is H12MDI.

The weight ratio of the first linear aliphatic diisocyanate to the second aliphatic diisocyanate is, in one embodiment, from 1:1 to 20:1, and in a further embodiment from 1:1 to 19:1, or even from 1:1 to 9:1. The weight ratio of first to second diisocyanate will be dependent on the desired hardness of the TPU, with lower Shore D values having a higher ratio of the first linear diisocyanate to the second diisocyanate, and higher Shore D values have a lower ratio of the first linear diisocyanate to the second diisocyanate.

### The Polyol Component

The TPU compositions described herein are made using: (b) a polyol component comprising at least one polyether polyol.

The invention further provides for the TPU compositions described herein wherein the polyether polyol has a number average molecular weight from 500 to 1,000 or, 600 to 1,000, or 1,000 to 3,000, or even from 500, or 600, or 1,500 to 2,500, or even about 2,000.

The invention further provides for the TPU compositions described herein wherein the polyol component that further includes a polyester polyol, a polycarbonate polyol, a polysiloxane polyol, or any combinations thereof.

In other embodiments, the polyol component is essentially free of (or even completely free of) any polyester polyols, polycarbonate polyols, polysiloxane polyols, or all of the above. In still other embodiments, the polyol component is essentially free of (or even completely free of) any polyol other than the linear polyether polyol described above, which in some embodiments is poly(tetramethylene oxide) (PTMO) which may also be described as the reaction product of water and tetrahydrofuran.

Suitable polyether polyols may also be referred to as hydroxyl terminated polyether intermediates, and include polyether polyols derived from a diol or polyol having a total of from 2 to 15 carbon atoms. In some embodiments, the diol or polyol is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) (PEG) comprising ethylene oxide reacted with ethylene glycol, poly(propylene glycol) comprising propylene oxide reacted with propylene glycol, poly(tetramethylene glycol) comprising water reacted with tetrahydrofuran (PTMEG). In some embodiments, the polyether intermediate includes PTMEG or

PEG or combinations thereof. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the technology described herein. Typical copolyethers include the reaction product of THF and ethylene oxide or THF and propylene oxide. These are available from BASF as Poly-THF®-B, a block copolymer, and poly-THF®-R, a random copolymer. The various polyether intermediates generally have a number average molecular weight (Mn) as determined by assay of the terminal functional groups which is an average molecular weight greater than about 700, or even from 700, 1,000, 1,500 or even 2,000 up to 10,000, 5,000, 3,000, 2,500, 2,000 or even 1,000. In some embodiments, the polyether intermediate includes a blend of two or more different molecular weight polyethers, such as a blend of 2,000 Mn PTMO and 1,000 Mn PTMO.

In some embodiments, the polyol component used to prepare the TPU composition described above can include one or more additional polyols. Examples of suitable additional polyols include a polycarbonate polyol, polysiloxane polyol, polyester polyols including polycaprolactone polyester polyols, polyamide oligomers including telechelic polyamide polyols, or any combinations thereof. In other embodiments, the polyol component used to prepare the TPU is free of one or more of these additional polyols, and in some embodiments the polyol component consists essentially of the polyether polyol described above. In some embodiments the polyol component consists of the polyether polyol described above. In other embodiments, the polyol component used to prepare the TPU is free of polyester polyols, polycarbonate polyols, polysiloxane polyols, polyamide oligomers including telechelic polyamide polyols, or even all of the above.

When present, these optional additional polyols may also be described as hydroxyl terminated intermediates. When present, they may include one or more hydroxyl terminated polyesters, one or more hydroxyl terminated polycarbonates, one or more hydroxyl terminated polysiloxanes, or mixtures thereof.

Suitable hydroxyl terminated polyester intermediates include linear polyesters having a number average molecular weight (Mn) of from about 500 to about 10,000, from about 700 to about 5,000, or from about 700 to about 4,000, and generally have an acid number generally less than 1.3 or less than 0.5. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is often a preferred acid. The glycols which are reacted to form a desirable polyester intermediate can be aliphatic, aromatic, or combinations thereof, including any of the glycol described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecular with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 1,6-2,2,4-trimethylhexanediol, 1,10-decanediol, hydrogenated dilinoleylglycol, hydrogenated dioleylglycol; and cycloaliphatic diols such as 1,3-cyclohexanediol, 1,4-dimethylolcyclohexane-, 1,4-cyclohexanediol, 1,3-dimethylolcyclohexane, 1,4-endo methylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Suitable polysiloxane polyols include alpha-omega-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5,000, or from 400 to 3,000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone. Suitable examples include alpha-omega-hydroxypropyl terminated poly(dimethysiloxane) and alpha-omega-amino propyl terminated poly(dimethysiloxane), both of which are commercially available materials. Further examples include copolymers of the poly(dimethysiloxane) materials with a poly(alkylene oxide).

The polyester polyols described above include polyester diols derived from caprolactone monomers. These polycaprolactone polyester polyols are terminated by primary hydroxyl groups. Suitable polycaprolactone polyester polyols may be made from ε-caprolactone and a bifunctional initiator such as diethylene glycol, 1,4-butanediol, or any of the other glycol and/or diol listed herein. In some embodiments, the polycaprolactone polyester polyols are linear polyester diols derived from caprolactone monomers.

Useful examples include CAPA™ 2202A, a 2,000 number average molecular weight (Mn) linear polyester diol, and CAPA™ 2302A, a 3,000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, hexane diol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol.

In some embodiments, the polycaprolactone polyester polyol has a number average molecular weight from 2,000 to 3,000.

Suitable polyamide oligomers, including telechelic polyamide polyols, are not overly limited and include low molecular weight polyamide oligomers and telechelic polyamides (including copolymers) that include N-alkylated amide groups in the backbone structure. Telechelic polymers are macromolecules that contain two reactive end groups. Amine terminated polyamide oligomers can be useful as polyols in the disclosed technology. The term polyamide oligomer refers to an oligomer with two or more amide linkages, or sometimes the amount of amide linkages will be specified. A subset of polyamide oligomers are telechelic polyamides. Telechelic polyamides are polyamide oligomers with high percentages, or specified percentages, of two functional groups of a single chemical type, e.g. two terminal amine groups (meaning either primary, secondary, or mixtures), two terminal carboxyl groups, two terminal hydroxyl groups (again meaning primary, secondary, or mixtures), or two terminal isocyanate groups (meaning aliphatic, aromatic, or mixtures). Ranges for the percent difunctional that can meet the definition of telechelic include at least 70, 80, 90 or 95 mole % of the oligomers being difunctional as opposed to higher or lower functionality. Reactive amine terminated telechelic polyamides are telechelic polyamide oligomers where the terminal groups are both amine types, either primary or secondary and mixtures thereof, i.e. excluding tertiary amine groups.

In one embodiment, the telechelic oligomer or telechelic polyamide will have a viscosity measured by a Brookfield circular disc viscometer with the circular disc spinning at 5 rpm of less than 100,000 cps at a temperature of 70° C., less than 15,000 or 10,000 cps at 70° C., less than 100,000 cps at 60 or 50° C., less than 15,000 or 10,000 cps at 60° C.; or less that 15,000 or 10,000 cps at 50° C. These viscosities are those of neat telechelic prepolymers or polyamide oligomers without solvent or plasticizers. In some embodiments the telechelic polyamide can be diluted with solvent to achieve viscosities in these ranges.

In some embodiments, the polyamide oligomer is a species below 20,000 g/mole molecular weight, e.g. often below 10,000; 5,000; 2,500; or 2000 g/mole, that has two or more amide linkages per oligomer. The telechelic polyamide has molecular weight preferences identical to the polyamide oligomer. Multiple polyamide oligomers or telechelic polyamides can be linked with condensation reactions to form polymers, generally above 100,000 g/mole.

Generally, amide linkages are formed from the reaction of a carboxylic acid group with an amine group or the ring opening polymerization of a lactam, e.g. where an amide linkage in a ring structure is converted to an amide linkage in a polymer. In one embodiment, a large portion of the amine groups of the monomers are secondary amine groups or the nitrogen of the lactam is a tertiary amide group. Secondary amine groups form tertiary amide groups when the amine group reacts with carboxylic acid to form an amide. For the purposes of this disclosure, the carbonyl group of an amide, e.g. as in a lactam, will be considered as derived from a carboxylic acid group. The amide linkage of a lactam is formed from the reaction of carboxylic group of an aminocarboxylic acid with the amine group of the same aminocarboxylic acid. In one embodiment we want less than 20, 10 or 5 mole percent of the monomers used in making the polyamide to have functionality in polymerization of amide linkages of 3 or more.

The polyamide oligomers and telechelic polyamides of this disclosure can contain small amounts of ester linkages, ether linkages, urethane linkages, urea linkages, etc. if the additional monomers used to form these linkages are useful to the intended use of the polymers.

As earlier indicated many amide forming monomers create on average one amide linkage per repeat unit. These include diacids and diamines when reacted with each other, aminocarboxylic acids, and lactams. These monomers, when reacted with other monomers in the same group, also create amide linkages at both ends of the repeat units formed. Thus we will use both percentages of amide linkages and mole percent and weight percentages of repeat units from amide forming monomers. Amide forming monomers will be used to refer to monomers that form on average one amide linkage per repeat unit in normal amide forming condensation linking reactions.

In one embodiment, at least 10 mole percent, or at least 25, 45 or 50, and or even at least 60, 70, 80, 90, or 95 mole % of the total number of the heteroatom containing linkages connecting hydrocarbon type linkages are characterized as being amide linkages. Heteroatom linkages are linkages such as amide, ester, urethane, urea, ether linkages where a heteroatom connects two portions of an oligomer or polymer that are generally characterized as hydrocarbons (or having carbon to carbon bond, such as hydrocarbon linkages). As the amount of amide linkages in the polyamide increase the amount of repeat units from amide forming monomers in the polyamide increases. In one embodiment at least 25 wt. %, or at least 30, 40, 50, or even at least 60, 70, 80, 90, or 95 wt. % of the polyamide oligomer or telechelic polyamide is repeat units from amide forming monomers, also identified as monomers that form amide linkages at both ends of the repeat unit. Such monomers include lactams, aminocarboxylic acids, dicarboxylic acid and diamines. In one embodiment, at least 50, 65, 75, 76, 80, 90, or 95 mole percent of the amide linkages in the polyamide oligomer or telechelic polyamine are tertiary amide linkages.

The percent of tertiary amide linkages of the total number of amide linkages was calculated with the following equation:

$$Tertiary amide linkage \% = \frac{{\sum }_{i = 1}^{n} ( {w}_{tertN , i} \times {n}_{i} )}{{\sum }_{i = 1}^{n} ( {w}_{totalN , i} \times {n}_{i} ) )} \times 100$$

where: n is the number of monomers; the index i refers to a certain monomer; w_{tertN} is the average number nitrogen atoms in a monomer that form or are part of tertiary amide linkages in the polymerizations, (note: end-group forming amines do not form amide groups during the polymerizations and their amounts are excluded from w_{tertN}); w_{totalN} is the average number nitrogen atoms in a monomer that form or are part of tertiary amide linkages in the polymerizations (note: the end-group forming amines do not form amide groups during the polymerizations and their amounts are excluded from w_{totalN}); and nᵢ is the number of moles of the monomer with the index i.

The percent of amide linkages of the total number of all heteroatom containing linkages (connecting hydrocarbon linkages) was calculated by the following equation:

$$Amide linkage \% = \frac{{\sum }_{i = 1}^{n} ( {w}_{totalN , i} \times {n}_{i} )}{{\sum }_{i = 1}^{n} ( {w}_{totalS , i} \times {n}_{i} ) )} \times 100$$

where: w_{totalS} is the sum of the average number of heteroatom containing linkages (connecting hydrocarbon linkages) in a monomer and the number of heteroatom containing linkages (connecting hydrocarbon linkages) forming from that monomer by the reaction with a carboxylic acid bearing monomer during the polyamide polymerizations; and all other variables are as defined above. The term “hydrocarbon linkages” as used herein are just the hydrocarbon portion of each repeat unit formed from continuous carbon to carbon bonds (i.e. without heteroatoms such as nitrogen or oxygen) in a repeat unit. This hydrocarbon portion would be the ethylene or propylene portion of ethylene oxide or propylene oxide; the undecyl group of dodecyllactam, the ethylene group of ethylenediamine, and the (CH₂)₄ (or butylene) group of adipic acid.

In some embodiments, the amide or tertiary amide forming monomers include dicarboxylic acids, diamines, aminocarboxylic acids and lactams. Suitable dicarboxylic acids are where the alkylene portion of the dicarboxylic acid is a cyclic, linear, or branched (optionally including aromatic groups) alkylene of 2 to 36 carbon atoms, optionally including up to 1 heteroatom per 3 or 10 carbon atoms of the diacid, more preferably from 4 to 36 carbon atoms (the diacid would include 2 more carbon atoms than the alkylene portion). These include dimer fatty acids, hydrogenated dimer acid, sebacic acid, etc.

Suitable diamines include those with up to 60 carbon atoms, optionally including one heteroatom (besides the two nitrogen atoms) for each 3 or 10 carbon atoms of the diamine and optionally including a variety of cyclic, aromatic or heterocyclic groups providing that one or both of the amine groups are secondary amines.

Such diamines include Ethacure™ 90 from Albermarle (supposedly a N,N′-bis(1,2,2-trimethylpropyl)-1,6-hexanediamine); Clearlink™ 1000 from Dorfketal, or Jefflink™ 754 from Huntsman; N-methylaminoethanol; dihydroxy terminated, hydroxyl and amine terminated or diamine terminated poly(alkyleneoxide) where the alkylene has from 2 to 4 carbon atoms and having molecular weights from about 40 or 100 to 2000; N,N′-diisopropyl-1,6-hexanediamine; N,N′-di(sec-butyl) phenylenediamine; piperazine; homopiperazine; and methyl-piperazine.

Suitable lactams include straight chain or branched alkylene segments therein of 4 to 12 carbon atoms such that the ring structure without substituents on the nitrogen of the lactam has 5 to 13 carbon atoms total (when one includes the carbonyl) and the substituent on the nitrogen of the lactam (if the lactam is a tertiary amide) is an alkyl group of from 1 to 8 carbon atoms and more desirably an alkyl group of 1 to 4 carbon atoms. Dodecyl lactam, alkyl substituted dodecyl lactam, caprolactam, alkyl substituted caprolactam, and other lactams with larger alkylene groups are preferred lactams as they provide repeat units with lower Tg values. Aminocarboxylic acids have the same number of carbon atoms as the lactams. In some embodiments, the number of carbon atoms in the linear or branched alkylene group between the amine and carboxylic acid group of the aminocarboxylic acid is from 4 to 12 and the substituent on the nitrogen of the amine group (if it is a secondary amine group) is an alkyl group with from 1 to 8 carbon atoms, or from 1 or 2 to 4 carbon atoms.

In one embodiment, desirably at least 50 wt. %, or at least 60, 70, 80 or 90 wt. % of said polyamide oligomer or telechelic polyamide comprise repeat units from diacids and diamines of the structure of the repeat unit being:

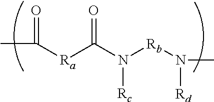

wherein: Rₐ is the alkylene portion of the dicarboxylic acid and is a cyclic, linear, or branched (optionally including aromatic groups) alkylene of 2 to 36 carbon atoms, optionally including up to 1 heteroatom per 3 or 10 carbon atoms of the diacid, more preferably from 4 to 36 carbon atoms (the diacid would include 2 more carbon atoms than the alkylene portion); and R_{b} is a direct bond or a linear or branched (optionally being or including cyclic, heterocyclic, or aromatic portion(s)) alkylene group (optionally containing up to 1 or 3 heteroatoms per 10 carbon atoms) of 2 to 36 or 60 carbon atoms and more preferably 2 or 4 to 12 carbon atoms and R_{c} and R_{d} are individually a linear or branched alkyl group of 1 to 8 carbon atoms, more preferably 1 or 2 to 4 carbon atoms or R_{c} and R_{d} connect together to form a single linear or branched alkylene group of 1 to 8 carbon atoms or optionally with one of R_{c} and R_{d} is connected to R_{b} at a carbon atom, more desirably R_{c} and R_{d} being an alkyl group of 1 or 2 to 4 carbon atoms.

In one embodiment, desirably at least 50 wt. %, or at least 60, 70, 80 or 90 wt. % of said polyamide oligomer or telechelic polyamide comprise repeat units from lactams or amino carboxylic acids of the structure:

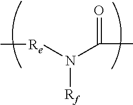

Repeat units can be in a variety of orientations in the oligomer derived from lactams or amino carboxylic acid depending on initiator type, wherein each Rₑ independently is linear or branched alkylene of 4 to 12 carbon atoms and each R_{f} independently is a linear or branched alkyl of 1 to 8, more desirably 1 or 2 to 4, carbon atoms.

In some embodiments, the telechelic polyamide polyols include those having (i) repeat units derived from polymerizing monomers connected by linkages between the repeat units and functional end groups selected from carboxyl or primary or secondary amine, wherein at least 70 mole percent of telechelic polyamide have exactly two functional end groups of the same functional type selected from the group consisting of amino or carboxylic end groups; (ii) a polyamide segment comprising at least two amide linkages characterized as being derived from reacting an amine with a carboxyl group, and said polyamide segment comprising repeat units derived from polymerizing two or more of monomers selected from lactams, aminocarboxylic acids, dicarboxylic acids, and diamines; (iii) wherein at least 10 percent of the total number of the heteroatom containing linkages connecting hydrocarbon type linkages are characterized as being amide linkages; and (iv) wherein at least 25 percent of the amide linkages are characterized as being tertiary amide linkages.

In some embodiments, the polyol component used to prepare the TPU further includes (or consists essentially of, or even consists of) a polyether polyol and one or more additional polyols selected from the group consisting of a polyester polyol, polycarbonate polyol, polysiloxane polyol, or any combinations thereof.

In some embodiments, the thermoplastic polyurethane is prepared with a polyol component that consists essentially of polyether polyol. In some embodiments, the thermoplastic polyurethane is prepared with a polyol component that consists of polyether polyol, and in some embodiments PTMO.

### The Chain Extender Component

The TPU compositions described herein are made using: (c) a chain extender component that includes at least one diol chain extender of the general formula HO—(CH₂)ₓ—OH wherein x is an integer from 2 to 6 or even from 4 to 6. In other embodiments, x is the integer 4.

Useful diol chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy)phenyl]propane (HEPP), heptanediol, nonanediol, dodecanediol, ethylenediamine, butanediamine, hexamethylenediamine, and hydroxyethyl resorcinol (HER), and the like, as well as mixtures thereof. In some embodiments, the chain extender includes BDO, HDO, or a combination thereof. In some embodiments, the chain extender includes BDO. Other glycols, such as aromatic glycols could be used, but in some embodiments the TPUs described herein are essentially free of or even completely free of such materials, or a combination thereof.

In some embodiments, the chain extender component may further include one or more additional chain extenders. These additional chain extenders are not overly limited and may include diols (other than those described above), diamines, and combinations thereof.

In some embodiments, the additional chain extender includes a cyclic chain extender. Suitable examples include CHDM, HEPP, HER, and combinations thereof. In some embodiments, the additional chain extender includes an aromatic cyclic chain extender, for example HEPP, HER, or a combination thereof. In some embodiments, the additional chain extender includes an aliphatic cyclic chain extender, for example CHDM. In some embodiments, the additional chain extender is substantially free of, or even completely free of aromatic chain extenders, for example aromatic cyclic chain extenders. In some embodiments, the additional chain extender is substantially free of, or even completely free of polysiloxanes.

In some embodiments, the chain extender component includes 1,9-nonanediol, 1,10-decanediol, 1,11-undecanediol, 1,12-dodecanediol, or a combination thereof. In some embodiments, the chain extender component includes 1,10-decanediol, 1,11-undecanediol, 1,12-dodecanediol, or a combination thereof. In some embodiments, the chain extender component includes 1,12-dodecanediol.

In some embodiments, the mole ratio of the chain extender to the polyol is greater than 1.5. In other embodiments, the molar ratio of the chain extender to the polyol is at least (or greater than) 1.5. In some embodiments, the molar ratio of the chain extender to the polyol is from 1.5 to 15.0. In some embodiments, the molar ratio of the chain extender to the polyol of the TPU is from 30:1 to 0.5:1, or from 21:1 to 0.7:1.

### The Thermoplastic Polyurethane Compositions

The thermoplastic polyurethanes described herein may also be considered to be thermoplastic polyurethane (TPU) compositions. In such embodiments, the compositions may contain one or more TPU. These TPU are prepared by reacting: a) the polyisocyanate component described above; b) the polyol component described above; and c) the chain extender component described above, where the reaction may be carried out in the presence of a catalyst. At least one of the TPU in the composition must meet the parameters described above making it suitable for solid freeform fabrication, and in particular fused deposition modeling.

The means by which the reaction is carried out is not overly limited, and includes both batch and continuous processing. In some embodiments, the technology deals with batch processing of aromatic TPU. In some embodiments, the technology deals with continuous processing of aromatic TPU.

The described compositions include the TPU materials described above and also TPU compositions that include such TPU materials and one or more additional components. These additional components include other polymeric materials that may be blended with the TPU described herein. These additional components include one or more additives that may be added to the TPU, or blend containing the TPU, to impact the properties of the composition.

The TPU described herein may also be blended with one or more other polymers. The polymers with which the TPU described herein may be blended are not overly limited. In some embodiments, the described compositions include two or more of the described TPU materials. In some embodiments, the compositions include at least one of the described TPU materials and at least one other polymer, which is not one of the described TPU materials.

Polymers that may be used in combination with the TPU materials described herein also include more conventional TPU materials such as non-caprolactone polyester-based TPU, polyether-based TPU, or TPU containing both non-caprolactone polyester and polyether groups. Other suitable materials that may be blended with the TPU materials described herein include polycarbonates, polyolefins, styrenic polymers, acrylic polymers, polyoxymethylene polymers, polyamides, polyphenylene oxides, polyphenylene sulfides, polyvinylchlorides, chlorinated polyvinyl chlorides, polylactic acids, or combinations thereof.

Polymers for use in the blends described herein include homopolymers and copolymers. Suitable examples include: (i) a polyolefin (PO), such as polyethylene (PE), polypropylene (PP), polybutene, ethylene propylene rubber (EPR), polyoxyethylene (POE), cyclic olefin copolymer (COC), or combinations thereof; (ii) a styrenic, such as polystyrene (PS), acrylonitrile butadiene styrene (ABS), styrene acrylonitrile (SAN), styrene butadiene rubber (SBR or HIPS), polyalphamethylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof; (iii) a thermoplastic polyurethane (TPU) other than those described above; (iv) a polyamide, such as Nylon™, including polyamide 6,6 (PA66), polyamide 1,1 (PA11), polyamide 1,2 (PA12), a copolyamide (COPA), or combinations thereof; (v) an acrylic polymer, such as polymethyl acrylate, polymethylmethacrylate, a methyl methacrylate styrene (MS) copolymer, or combinations thereof; (vi) a polyvinylchloride (PVC), a chlorinated polyvinylchloride (CPVC), or combinations thereof; (vii) a polyoxyemethylene, such as polyacetal; (viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), polylactic acid (PLA), polyglycolic acid (PGA), copolymers of PLA and PGA, or combinations thereof; (ix) a polycarbonate (PC), a polyphenylene sulfide (PPS), a polyphenylene oxide (PPO), or combinations thereof; or combinations thereof.

In some embodiments, these blends include one or more additional polymeric materials selected from groups (i), (iii), (vii), (viii), or some combination thereof. In some embodiments, these blends include one or more additional polymeric materials selected from group (i). In some embodiments, these blends include one or more additional polymeric materials selected from group (iii). In some embodiments, these blends include one or more additional polymeric materials selected from group (vii). In some embodiments, these blends include one or more additional polymeric materials selected from group (viii).

The additional optional additives suitable for use in the TPU compositions described herein are not overly limited. Suitable additives include pigments, UV stabilizers, UV absorbers, antioxidants, lubricity agents, heat stabilizers, hydrolysis stabilizers, cross-linking activators, biocompatible flame retardants, layered silicates, colorants, reinforcing agents, adhesion mediators, impact strength modifiers, antimicrobials, radio opacifiers, non-oxide bismuth salts, tungsten metal, fillers and any combination thereof. It is to be noted that the TPU compositions of the invention disclosed herein do not require the use of inorganic, organic or inert fillers, such as talc, calcium carbonate, or TiO2 powders which, while not wishing to be bound by theory, it is believed may assist in printability of the TPU composition. Thus, in some embodiments, the disclosed technology may include a fillers and in some embodiments, the disclosed technology may be free of fillers.

The TPU compositions described herein may also include additional additives, which may be referred to as a stabilizer. The stabilizers may include antioxidants such as phenolics, phosphites, thioesters, and amines, light stabilizers such as hindered amine light stabilizers and benzothiazole UV absorbers, and other process stabilizers and combinations thereof. In one embodiment, the preferred stabilizer is Irganox 1010 from BASF and Naugard 445 from Chemtura. The stabilizer is used in the amount from about 0.1 weight percent to about 5 weight percent, in another embodiment from about 0.1 weight percent to about 3 weight percent, and in another embodiment from about 0.5 weight percent to about 1.5 weight percent of the TPU composition.

Still further optional additives may be used in the TPU compositions described herein. The additives include colorants, antioxidants (including phenolics, phosphites, thioesters, and/or amines), stabilizers, lubricants, inhibitors, hydrolysis stabilizers, light stabilizers, hindered amines light stabilizers, benzotriazole UV absorber, heat stabilizers, stabilizers to prevent discoloration, dyes, pigments, reinforcing agents and combinations thereof.

All of the additives described above may be used in an effective amount customary for these substances. The non-flame retardants additives may be used in amounts of from about 0 to about 30 weight percent, in one embodiment from about 0.1 to about 25 weight percent, and in another embodiment about 0.1 to about 20 weight percent of the total weight of the TPU composition.

These additional additives can be incorporated into the components of, or into the reaction mixture for, the preparation of the TPU resin, or after making the TPU resin. In another process, all the materials can be mixed with the TPU resin and then melted or they can be incorporated directly into the melt of the TPU resin.

The TPU materials described above may be prepared by a process that includes the step of (I) reacting: a) the polyisocyanate component described above, that includes a first and a second linear aliphatic diisocyanate; b) the polyol component described above, that includes a polyether polyol; and c) the chain extender component described above, that includes at least one diol chain extender of the general formula HO(CH₂)ₓ—OH wherein x is an integer from 2 to about 6 or even 2 to 4, where the reaction may be carried out in the presence of a catalyst, resulting in a thermoplastic polyurethane composition.

The process may further include the step of: (II) mixing the TPU composition of step (I) with one or more blend components, including one or more additional TPU materials and/or polymers, including any of those described above.

The process may further include the step of: (II) mixing the TPU composition of step (I) with one or more of the additional additives described above.

The process may further include the step of: (II) mixing the TPU composition of step (I) with one or more blend components, including one or more additional TPU materials and/or polymers, including any of those described above, and/or the step of: (III) mixing the TPU composition of step (I) with one or more of the additional additives described above.

The resulting TPU has: i) a Shore D hardness, as measured by ASTM D2240, from 20 to 80 or even 20 to 75, or even from 20 to 70; ii) a rebound recovery as measured by ASTM D2632, from 30 to 60, or even from 40 to 50; iii) a creep recovery as measured by ASTM D2990-01 of from 30 to 90, or from 40 to 80; iv) a tensile strength as measured by ASTM D412 of from 4,000 psi to 10,000 psi; a wet flexural modulus as measured by ASTM D790 of from about 3,000 to about 55,000; and vi) an elongation at break as measured by ASTM D412 of from 250 percent to 1000 percent.

In some embodiments, the TPU compositions of the invention have a hard segment content of 15 to 85 percent by weight, where the hard segment content is the portion of the TPU derived from the polyisocyanate component and the chain extender component (the hard segment content of the TPU may be calculated by adding the weight percent content of chain extender and polyisocyanate in the TPU and dividing that total by the sum of the weight percent contents of the chain extender, polyisocyanate, and polyol in the TPU). In other embodiments, the hard segment content is from 5 to 95, or from 10 to 90, or from 15 to 85 percent by weight. The remainder of the TPU is derived from the polyol component, which may be present from 10 to 90 percent by weight, or even from 15 to 85 percent by weight.

### The Systems and Methods.

The solid freeform fabrication systems and the methods of using the same useful in the described technology are not overly limited. It is noted that the described technology provides certain thermoplastic polyurethanes that are better suited for the solid freeform fabrication of medical devices and components, than current materials and other thermoplastic polyurethanes. It is noted that some solid freeform fabrication systems, including some fused deposition modeling systems may be better suited for processing certain materials, including thermoplastic polyurethanes, due to their equipment configurations, processing parameters, etc. However, the described technology is not focused on the details of solid freeform fabrication systems, including some fused deposition modeling systems, rather the described technology is focused on providing certain thermoplastic polyurethanes that are better suited for solid freeform fabrication of medical devices and components.

The extrusion-type additive manufacturing systems and processes useful in the present invention include systems and processes that build parts layer-by-layer by heating the building material to a semi-liquid state and extruding it according to computer-controlled paths. The material, supplied as a strand or resin, may be dispensed as a semi-continuous flow and/or filament of material from the dispenser or it may alternatively be dispensed as individual droplets. FDM often uses two materials to complete a build. A modeling material is used to constitute the finished piece. A support material may also be used to act as scaffolding for the modeling material. The building material, e.g., TPU, is fed from the systems material stores to its print head, which typically moves in a two dimensional plane, depositing material to complete each layer before the base moves along a third axis to a new level and/or plane and the next layer begins. Once the system is done building, the user may remove the support material away or even dissolve it, leaving a part that is ready to use. In some embodiments, the additive manufacturing systems and processes will include a support material which includes a TPU different from the inventive TPU disclosed herein. In some embodiments, the systems and processes are free of the support material.

The powder or granular type of additive manufacturing systems and processes useful in the present invention SLS involves the use of a high power laser (for example, a carbon dioxide laser to fuse small particles of the material, e.g. TPU, into a mass that has a desired three-dimensional shape. Production by selective fusion of layers is a method for producing articles that consists in depositing layers of materials in powder form, selectively melting a portion or a region of a layer, depositing a new layer of powder and again melting a portion of said layer, and continuing in this manner until the desired object is obtained. The selectivity of the portion of the layer to be melted is obtained for example by using absorbers, inhibitors, masks, or via the input of focused energy, such as a laser or electromagnetic beam, for example. Sintering by the addition of layers is preferred, in particular rapid prototyping by sintering using a laser. Rapid prototyping is a method used to obtain parts of complex shape without tools and without machining, from a three-dimensional image of the article to be produced, by sintering superimposed powder layers using a laser. General information about rapid prototyping by laser sintering is provided in U.S. Pat. No. 6,136,948 and applications WO96/06881 and US20040138363.

Machines for implementing these methods may comprise a construction chamber on a production piston, surrounded on the left and right by two pistons feeding the powder, a laser, and means for spreading the powder, such as a roller. The chamber is generally maintained at constant temperature to avoid deformations.

Other production methods by layer additions' such as those described in WO 01/38061 and EP1015214 are also suitable. These two methods use infrared heating to melt the powder. The selectivity of the molten parts is obtained in the case of the first method by the use of inhibitors, and in the case of the second method by the use of a mask. Another method is described in application DE10311438. In this method, the energy for melting the polymer is supplied by a microwave generator and selectivity is obtained by using a susceptor.

The disclosed technology further provides the use of the described thermoplastic polyurethanes in the described systems and methods, and the medical devices and components made from the same.

### The Medical Devices, Components and Applications.

The processes described herein may utilize the thermoplastic polyurethanes described herein to produce various medical devices and components and medical applications.

As with all additive manufacturing there is particular value for such technology in making articles as part of rapid prototyping and new product development, as part of making custom and/or one time only parts, or similar applications where mass production of an article in large numbers is not warranted and/or practical.

Useful medical devices and components which may be formed from the compositions of the invention include: liquid storage containers such as bags, pouches, and bottles for storage and IV infusion of blood or solutions. Other useful items include medical tubing and medical valves for any medical device including infusion kits, catheters, prosthetics, braces, and respiratory therapy.

Still further useful applications and articles include: biomedical devices including implantable devices, pacemaker leads, artificial hearts, heart valves, stent coverings, pacemaker heads, angiography, angioplasty, epidural, thermal dilution and urology catheters, catheter connectors, artificial tendons, arteries and veins, medical bags, medical tubing, cartilage replacement, hair replacement, joint replacement, drug delivery devices such as intravaginal rings, implants containing pharmaceutically active agents, bioabsorbable implants, surgical planning, prototypes, and models.

Of particular relevance are personalized medical articles, such as orthotics, implants, bones substitutes or devices, dental items, veins, airway stents etc., that are customized to the patient. For example, bone sections and/or implants may be prepared using the systems and methods described above, for a specific patient where the implants are designed specifically for the patient.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. The products formed thereby, including the products formed upon employing the composition of the technology described herein in its intended use, may not be susceptible of easy description. Nevertheless, all such modifications and reaction products are included within the scope of the technology described herein; the technology described herein encompasses the composition prepared by admixing the components described above.

### EXAMPLES

The technology described herein may be better understood with reference to the following non-limiting examples.

Materials.

Several thermoplastic polyurethanes (TPU) are prepared and evaluated for their suitability of use in direct solid free form fabrication of a medical device. Inventive TPU-A is polyether TPU containing a polytetramethylene glycol polyol with a molar ratio of chain extender to polyol of about 1.91. Inventive TPU-B is polyether TPU containing a polytetramethylene polyol with a molar ratio of chain extender to polyol of about 3.21. Inventive TPU-C is a polyether TPU containing a polytetramethylene polyol with a molar ratio of chain extender to polyol of about 9.31. Inventive TPU-D is a polyether TPU containing a polytetramethylene polyol with a molar ratio of chain extender to polyol of about 13.45. Comparative TPU-E is an aromatic (MDI) polyether TPU containing polytetramethylene glycol polyol with a molar ratio of chain extender to polyol of about 3.51.

Each TPU material is tested to determine its suitability for use in select freeform fabrication processes. Each TPU material is extruded from resin into approximately 1.8 mm diameter rods using s single screw extruder. Tensile bars are printed utilizing a fused deposition modeling process on a MakerBot 2× desktop 3D printer running MakerBot Desktop Software Version 3.7 with the following test parameters:

| | |
|---|---|
| Extrusion Temperature | 200° C.-230° C. |
| Build Platform Temperature | 40° C.-150° C. |
| Print Speed | 30 mm/s-120 mm/s |

Results of this testing are summarized below in Table 1.

TABLE 1

| | TPU-A | TPU-B | TPU-C | TPU-D | TPU-E |
|---|---|---|---|---|---|
| Chain Extender:Polyol | 1.91 | 3.21 | 9.31 | 13.45 | 3.51 |
| mole ratio | | | | | |
| Print Speed (mm/sec) | 90 | 90 | 90 | 110 | 30 |

As illustrated by the results, the inventive TPU compositions provide compositions which are suitable for solid freeform fabrication.

Molecular weight distributions can be measured on the Waters gel permeation chromatograph (GPC) equipped with Waters Model 515 Pump, Waters Model 717 autosampler and Waters Model 2414 refractive index detector held at 40° C. The GPC conditions may be a temperature of 40° C., a column set of Phenogel Guard+2× mixed D (5 u), 300×7.5 mm, a mobile phase of tetrahydrofuran (THF) stabilized with 250 ppm butylated hydroxytoluene, a flow rate of 1.0 ml/min, an injection volume of 50 μl, sample concentration ˜0.12%, and data acquisition using Waters Empower Pro Software. Typically a small amount, typically approximately 0.05 gram of polymer, is dissolved in 20 ml of stabilized HPLC-grade THF, filtered through a 0.45-micron polytetrafluoroethylene disposable filter (Whatman), and injected into the GPC. The molecular weight calibration curve may be established with EasiCal® polystyrene standards from Polymer Laboratories.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the technology described herein can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration. That is “consisting essentially of” permits the inclusion of substances that do not materially affect the basic and novel characteristics of the composition under consideration.

While certain representative embodiments and details have been shown for the purpose of illustrating the subject technology described herein, it will be apparent to those skilled in this art that various changes and modifications can be made therein without departing from the scope of the subject invention. In this regard, the scope of the technology described herein is to be limited only by the following claims.

1. A medical device or component, comprising:
an additive-manufactured thermoplastic polyurethane composition derived from (a) a polyisocyanate component comprising at least a first linear aliphatic diisocyanate and a second aliphatic diisocyanate in a weight ratio of first linear aliphatic diisocyanate to the second aliphatic diisocyanate from 1:1 to 20:1, (b) a polyol component comprising at least one polyether polyol, and (c) a chain extender component comprising at least one diol chain extender of the general formula HO—(CH₂)ₓ—OH wherein x is an integer from 2 about to about 6;
wherein the molar ratio of chain extender component to polyol component is at least 1.5.

2. The medical device or component of claim 1, wherein the molar ratio of chain extender to polyol component is from 1.5 to 15.0.

3. The medical device or component of claim 1, wherein the molar ratio of chain extender to polyol component is from 1:1 to 19:1.

4. (canceled)

5. The medical device or component of claim 1, wherein the additive manufacturing comprises fused deposition modeling or selective laser sintering.

6. The medical device or component of claim 1, wherein the thermoplastic polyurethane is biocompatible.

7. The medical device or component of any of claim 1, wherein the polyol has a number average molecular weight of at least 500.

8. The medical device or component of claim 1, wherein the polyol component has a number average molecular weight of from 500 to 3,000.

9. The medical device or component of claim 1, wherein the first and second aliphatic diisocyanate components comprise 1,6-hexanediisocyanate and H12MDI.

10. The medical device or component of claim 1, wherein the polyol component comprises a polyether polyol comprising one or more of PTMO, PEG or combinations thereof.

11. The medical device or component of claim 1, wherein the molar ratio of chain extender to polyol is from 30:1 to 0.5:1.

12. The medical device or component of claim 1, wherein the molar ratio of chain extender to polyol is from 21:1 to 0.7:1.

13. The medical device or component of claim 1, wherein the chain extender component comprises 1, 4-butanediol.

14. The medical device or component of claim 1, wherein the chain extender component comprises from 2 wt % to 30 wt % of the total weight of the composition.

15. The medical device or component of claim 1, wherein the polyisocyanate component further comprise MDI, TDI, IPDI, LDI, BDI, PDI, CHDI, TODI, NDI, HXDI or any combination thereof.

16. The medical device or component of claim 1, wherein the polyol component further comprises a polyester polyol, a polycarbonate polyol, a polysiloxane polyol, a polyamide oligomer polyol, or any combination thereof.

17. The medical device or component of claim 1, wherein the chain extender component further comprises one or more additional diol chain extenders, diamine chain extenders, or a combination thereof.

18. The medical device or component of claim 1, wherein the chain extender component comprises 1,4-butane diol and the polyol component comprises poly(tetramethylene ether glycol).

19. The medical device or component of claim 1, wherein the chain extender component comprises 1,4-butane diol and the polyol component comprises PEG.

20. The medical device or component of claim 1, wherein the chain extender component comprises 1,4-butane diol and the polyol component comprises a combination of poly(tetramethylene ether glycol) and PEG.

21. The medical device or component of claim 1, wherein the thermoplastic polyurethane further comprises one or more colorants, antioxidants (including phenolics, phosphites, thioesters, and/or amines), radio opacifiers, stabilizers, lubricants, inhibitors, hydrolysis stabilizers, light stabilizers, hindered amines light stabilizers, benzotriazole UV absorber, heat stabilizers, stabilizers to prevent discoloration, dyes, pigments, reinforcing agents, or any combinations thereof.

22. The medical device or component of claim 1, wherein the thermoplastic polyurethane is free of inorganic, organic or inert fillers.

23. The medical device or component of claim 1, wherein the medical device or component comprises one or more of a pacemaker lead, an artificial organ, an artificial heart, a heart valve, an artificial tendon, an artery or vein, a pacemaker head, an angiography catheter, an angioplasty catheter, an epidural catheter, a thermal dilution catheter, a urology catheter, a catheter connector, a stent covering, an implant, a medical bag, a prosthetic device, a cartilage replacement, a hair replacement, a joint replacement, a medical valve, a medical tube, a drug delivery device, a bioabsorbable implant, a medical prototype, a medical model, an orthotic, a bone, a dental item, or a surgical tool.

24. The medical device or component of claim 23, wherein the device or component is personalized to a patient.

25. The medical device or component of claim 1, wherein the medical device or component comprises an implantable or non-implantable device or component.

26. A medical device made using a solid free-form fabrication method, comprising: a thermoplastic polyurethane derived from (a) a polyisocyanate component comprising at least a first linear aliphatic diisocyate and a second aliphatic diisocyanate in a weight ratio of first linear aliphatic diisocyanate to the second aliphatic diisocyanate from 1:1 to 20:1, (b) a polyether polyol component, and (c) a chain extender component;
wherein the ratio of (c) to (b) is from 1.5 to 15.0; and
wherein the thermoplastic polyurethane is deposited in successive layers to form a three-dimensional medical device or component.

27. A method of directly fabricating a three-dimensional medical device or component, comprising the step of: (I) operating a system for solid freeform fabrication of an object;
wherein said system comprises a solid freeform fabrication apparatus that operates to form a three-dimensional medical device or component from a building material comprising a thermoplastic polyurethane derived from (a) a polyisocyanate component comprising at least a first linear aliphatic diisocyanate and a second aliphatic diisocyanate in a weight ratio of first linear aliphatic diisocyanate to the second aliphatic diisocyanate from 1:1 to 20:1, (b) a polyether polyol component, and (c) a chain extender component.

28. A directly formed medical device or component, comprising:
a selectively deposited thermoplastic polyurethane composition derived from (a) a polyisocyanate component comprising at least a first linear aliphatic diisocyanate and a second aliphatic diisocyanate in a weight ratio of first linear aliphatic diisocyanate to the second aliphatic diisocyanate from 1:1 to 20:1, (b) a polyether polyol component, and (c) a chain extender component;
wherein the molar ratio of chain extender component to polyol component is at least 1.5.

29. A directly formed medical device or component for use in a medical application, comprising:
a selectively deposited thermoplastic polyurethane composition derived from (a) a polyisocyanate component comprising at least a first linear aliphatic diisocyanate and a second aliphatic diisocyanate in a weight ratio of first linear aliphatic diisocyanate to the second aliphatic diisocyanate from 1:1 to 20:1, (b) a polyether polyol component, and (c) a chain extender component;
wherein the molar ratio of chain extender component to polyol component is at least 1.5.

30. The medical device or component of claim 29, wherein the medical application comprises one or more of a dental, an orthotic, a maxio-facial, an orthopedic, or a surgical planning application.
